(19) United States
(12) Patent Application Publication
(10) Pub. No.: US 2015/0190981 A1
(43) Pub. Date: Jul. 9, 2015

(54) METALLIC CORE HAVING A HIGH COMPRESSION STRENGTH AND ARTICLES MADE FROM SAME

(71) Applicant: E I DU PONT DE NEMOURS AND COMPANY, Wilmington, DE (US)

(72) Inventors: MIKHAIL R LEVIT, Glen Allen, VA (US); Jian Wang, Midlothian, VA (US)

(21) Appl. No.: 14/590,172

(22) Filed: Jan. 6, 2015

Related U.S. Application Data
(60) Provisional application No. 61/924,929, filed on Jan. 8, 2014.

(51) Int. Cl. B32B 3/12; B32B 15/08

(52) U.S. Cl. CPC B32B 3/12; B32B 15/08; B32B 2250/02

(57) ABSTRACT

This invention relates to a metallic honeycomb or folded core having improved compression strength. The core comprises metal foil coated with matrix resin wherein the resin comprises at least 20 weight percent of the total weight of resin plus foil.

### BACKGROUND OF THE INVENTION

1. Field of the Invention

This invention relates to a high compression strength structural core made from a metallic foil.

2. Description of Related Art

Core structures for composite sandwich panels from aluminum or other metallic foil, mostly in the form of a honeycomb, are used in different applications but primary for aerospace and ground transportation where strength to weight or stiffness to weight ratios have high values. Traditionally, such metallic honeycomb structures have been made through expansion or corrugation processes. The only use of resins in such cores was to glue sheets together (node line adhesive) or provide a thin and light protective coating to metal sheets against corrosion. Improvements in the mechanical properties of metallic honeycomb were mostly achieved through increasing the honeycomb density through going to smaller cell sizes or by using thicker foil or by both methods. However, compression strength of metallic honeycombs remains lower than the compression strengths of non-metallic honeycomb of comparable cell size and density.

There remains a need for further improvement in the mechanical properties, particularly compression strength, of metallic core structures.

There is a further need to enhance the electrical resistivity of metallic core structures, especially where they are used in conjunction with electrically conductive facesheets.

### BRIEF SUMMARY OF THE INVENTION

This invention pertains to a honeycomb comprising a plurality of interconnected walls having surfaces that define a plurality of honeycomb cells, wherein the cell walls are of a metallic foil coated with matrix resin wherein the resin comprises at least 20 weight percent of the total weight of resin plus foil. The invention is further directed to a composite sandwich panel comprising a resin coated metallic core coated with matrix resin and at least one facesheet attached to at least one exterior surface of the core.

### BRIEF DESCRIPTION OF THE DRAWINGS

FIGS. 1a and 1b are representations of views of a hexagonal shaped honeycomb.

FIG. 2 is a representation of another view of a hexagonal cell shaped honeycomb.

FIG. 3 is an illustration of honeycomb provided with facesheets.

FIG. 4 a perspective view of a folded core structure.

### DETAILED DESCRIPTION OF THE INVENTION

### Core

Preferably, the core of this invention is a honeycomb core although other core structures such as folded core may also utilize the invention. The metallic foil of the core can be made from aluminum, stainless steel, or other metal or alloys of these metals. Suitable aluminum foil types include grades 3003, 5052 and 5056. The foil may be cleaned and/or etched prior to application of the coating resin. A primer coating may also be applied.

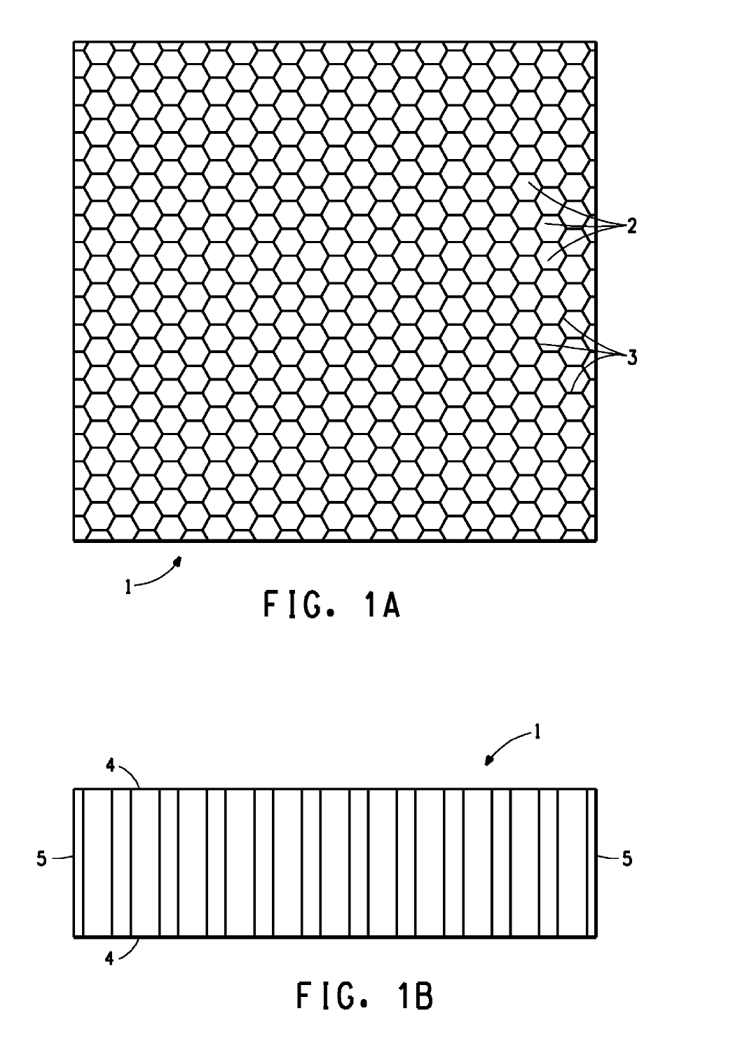

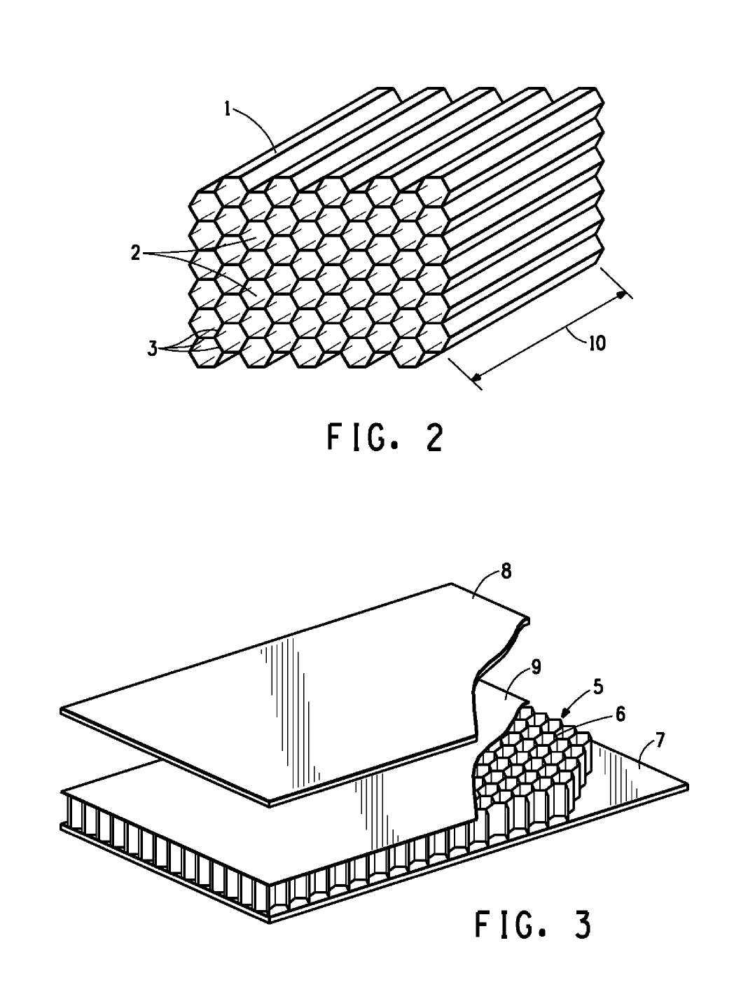

FIG. 1a is a plan view illustration of one honeycomb 1 of this invention and shows cells 2 formed by cell walls 3. FIG. 1b is an elevation view of the honeycomb shown in FIG. 1a and shows the two exterior surfaces, or faces 4 formed at both ends of the cell walls. The core also has edges 5. FIG. 2 is a three-dimensional view of the honeycomb. Shown is honeycomb 1 having hexagonal cells 2 and cell walls 3. The “T” dimension or the thickness of the honeycomb is shown in FIG. 2. Hexagonal cells are shown; however, other geometric arrangements are possible with square, over-expanded and flex-core cells being among the most common possible arrangements. Such cell types are well known in the art and reference can be made to Honeycomb Technology by T. Bitzer (Chapman & Hall, publishers, 1997) for additional information on possible geometric cell types.

Processes for converting the metallic foil into honeycomb core are well known to those skilled in the art and include expansion and corrugation. The expansion process is particularly well suited for core from thin foil. Such processes are further detailed on page 721 of the Engineered Materials Handbook, Volume 1—Composites, ASM International, 1988. The foil may be coated with a matrix resin before or after formation of the honeycomb. The final mechanical strength of core is a result of a combination of several factors. The principal contributors are foil type and thickness, cell size, and final core density such as after coating with resin. Cell size is the diameter of an inscribed circle within the cell of a honeycomb core. For metal foil core, typical cell sizes range from ⅛″-¼″ (3.2 mm-6.2 mm) but other sizes are possible. Typical final core densities are in the range of 38-96 kg/m³.

A folded core is a 3-dimensional structure of folded geometric patterns folded from a relatively thin planar sheet material. Such folded or tessellated sheet structures are discussed in U.S. Pat. Nos. 6,935,997 B2 and 6,800,351 B1. A chevron is a common pattern for three dimensional folded core structures. Folded core structures are different from honeycomb core structures. A preferred folded structure is of the type described in United States patent number 6,913,570 B2 and United States patent publication number 2010/0048078.

### Matrix Resin

The matrix resin used to coat the foil can be any suitable resin including but not limited to phenolic, epoxy, acrylic, polyimide, polybenzoxazine, polyetherimide and mixtures thereof. United States Military Specification MIL-R-9299C specifies typical resin properties. The resin may also contain other materials that enhance properties or provide additional functionality to the finished core. Examples include thermoplastic toughening agents, and fibers such as nano-fibers having a major dimension of less than 1 micrometer.

Preferably, the resin coating is present in an amount such that the resin comprises at least 20 weight percent of the total weight of resin plus foil. In some embodiments, the resin coating is present in an amount of from 20 to 70 weight percent of the total weight of resin plus foil. In some embodiments, the resin coating is present in an amount of from 20 to 40 weight percent or even from 40to 70 weight percent of the total weight of resin plus foil.

### Composite Panel

In some embodiments a composite sandwich panel comprises a metallic honeycomb core coated with matrix resin as described above and at least one facesheet attached to at least one exterior surface of the core. Preferably, at least one facesheet is attached to both exterior surfaces of the core.

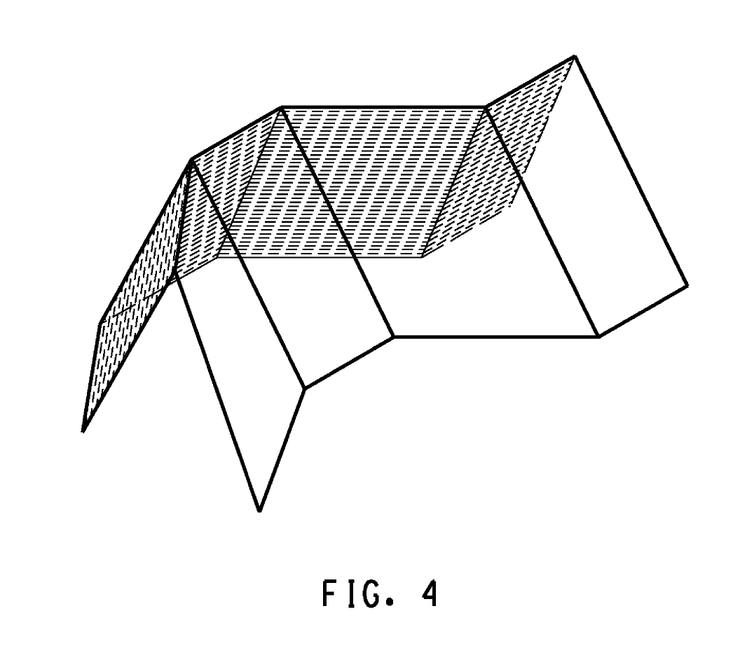

FIG. 3 shows a structural composite sandwich panel 5 assembled from a honeycomb core 6 with facesheets 7 and 8, attached to the two exterior surfaces of the core. The preferred facesheet material is a prepreg, a fibrous sheet impregnated with thermoset or thermoplastic resin, although metallic or plastic face sheets may also be utilized. With metallic face sheets, and in some circumstances with prepreg and plastic facesheets, an adhesive film 9 is also used. Normally there are at least two prepreg facesheets on either side of the core.

The reinforcing fiber of the prepreg is typically carbon, glass, aramid or a combination of these fibers. The reinforcing fibers may be provided in the form of a woven fabric, a nonwoven fabric or a unidirectional fabric.

### Test Methods

Core density was measured in accordance with ASTM C 271.

Compression strength of the core was measured in accordance with ASTM C 365.

Electrical resistance was measured by making a 7.6 cm×7.6 cm sandwich structure in which a 178 gsm, 0.02 mm thick stainless steel plate was adhesively bonded to a 1.5 cm thick slice of core. The electrical resistance through the panel was measured by placing a contact probe of a multimeter on each steel plate.

### EXAMPLES

### Comparative Example A

Slices of aluminum core type ECM 4,8-77 were obtained from Euro-Composites, Echternach, Luxembourg. The core slice was 155 mm thick, had a cell size of 4.8 mm and density of 91 kg/m³. The core was tested as received for compressive strength, the results being shown in Table 1.

### Example 1

The core of Comparative Example A was treated with acetone, dried, then treated with chromic acid solution by immersion at 70 degrees C. for 10 minutes, rinsed thoroughly with water and dried. The dried core was then dipped in a solution of GP® 445D05 RESI-SET® phenolic resin supplied by Georgia-Pacific Resins, Inc., Decatur, Ga. After dipping, the core was heat treated to cure the resin using a step cure cycle of 15 minutes at 82 degrees C., 15 minutes at 121 degrees C., and 60 minutes at 182 degrees C. The dipping and curing steps were repeated for the second time with the core sliced flipped over in the second dipping process. The resin content in the final honeycomb core was 21 weight percent of the total weight of core plus resin. Compression testing was repeated and the results shown in Table 1.

TABLE 1

| | Uncoated Core | Resin Coated Core |
|---|---|---|
| Core Density (kg/m³) | 93 | 115 |
| Bare Compression | 4.52 | 6.46 |
| Strength (MPa) | | |
| Specific Compression | 48.6 | 56.2 |
| Strength [kPa/(kg/m3)] | | |

As can be seen from the table, the addition of 21 weight percent of phenolic resin as a coating to aluminum honeycomb core increased the specific compression strength of the core (ratio of compression strength to density of the core) by 16%—from 48.6 to 56.2 kPa/(kg/m³). Surprisingly, an addition of a matrix resin coating is a more efficient tool for enhancing the compression strength of the core than developing this property solely through optimization of the metal foil.

The electrical resistance of the test sandwich panel was 0.2 Ohms for uncoated core and 0.6 Ohms for resin coated core thus demonstrating the additional benefit of reduced conductivity (increased resistivity) provided by the resin coated metal core. This is an attractive feature in reducing undesirable galvanic corrosion in sandwich panels comprising metallic core and conductive facesheets such as metallic or carbon facesheets.

What is claimed:

1. A honeycomb comprising a plurality of interconnected walls having surfaces that define a plurality of honeycomb cells, wherein the cell walls are of a metallic foil coated with matrix resin wherein the resin comprises at least 20 weight percent of the total weight of resin plus foil.

2. A honeycomb of claim 1 wherein the metallic foil is aluminum or an aluminum alloy.

3. A honeycomb of claim 1 wherein matrix resin coating is phenolic, epoxy, acrylic, polyimide, polybenzoxazine, polyetherimide or mixtures thereof.

4. A honeycomb of claim 1 wherein matrix resin coating further comprised additives having a major dimension of less than 1 micrometer.

5. A composite sandwich panel comprising a metallic honeycomb core of claim 1 and at least one facesheet attached to at least one exterior surface of the core.

6. The panel according of claim 5, wherein the facesheet comprises resin impregnated fiber, plastic or metal.

7. A folded core comprising a plurality of folded configurations made from a substrate, wherein the substrate further comprises a metallic foil coated with matrix resin, the resin comprising at least 20 weight percent of the total weight of resin plus foil.

8. A composite sandwich panel comprising a metallic folded core of claim 7 and at least one facesheet attached to at least one exterior surface of the core.
